(19) United States
(12) Patent Application Publication
(10) Pub. No.: US 2016/0236364 A1
(43) Pub. Date: Aug. 18, 2016

(54) RAZOR BLADE ASSEMBLY WITH FRICTION SURFACE

(71) Applicant: TECHNION RESEARCH & DEVELOPMENT FOUNDATION LIMITED, Haifa (IL)

(72) Inventors: Michael VARENBERG, Haifa (IL); Alexey TSIPENYUK, Gadot (IL); Yehuda YAVETS-CHEN, Caesarea (IL)

(21) Appl. No.: 15/027,469

(22) PCT Filed: Nov. 3, 2014
(86) PCT No.: PCT/IL2014/050946

§ 371 Date: Apr. 6, 2016

Related U.S. Application Data
(60) Provisional application No. 61/899,366, filed on Nov. 4, 2013.

(51) Int. Cl. B26B 21/40; B26B 21/44

(52) U.S. Cl. CPC B26B 21/4018; B26B 21/443

(57) ABSTRACT

A razor blade assembly (12) device includes one or more razor blades (22) configured to shave a skin surface when drawn across the skin surface in a forward direction. A friction surface (20) is situated in front of the razor blades. The friction surface includes an array of raised separated projections (24). Distal ends of the raised projections terminate in substantially flat faces. total area of the flat faces is greater than 10% of the area of the friction surface

### FIELD OF THE INVENTION

The present invention relates to razor blades. More particularly, the present invention relates to a razor blade assembly with a friction surface.

### BACKGROUND OF THE INVENTION

A typical modern safety razor includes a disposable cartridge or is entirely disposable. Various components of the razor cartridge or head are intended to increase the closeness of the shave or the comfort of the person being shaved. For example, many razor cartridges include multiple blades. Guards are placed on either side of the blades to prevent cutting of the skin being shaved.

Guards of a razor cartridge are often designed to provide other benefits when shaving. For example, a guard may be provided with structure that is designed to stretch the skin prior to shaving with the blades. The guard may include structure that is designed to provide a pleasant sensation during shaving. For example, some guards of razor cartridges are provided with a region filled with narrow rubber projections. A guard may include structure that is designed to dispense a lubricant substance during shaving. For example, a guard may include a strip that is permeated with a lubricant solution.

### SUMMARY OF THE INVENTION

There is thus provided, in accordance with some embodiments of the present invention, a razor blade assembly device including: one or a plurality of razor blades configured to shave a skin surface when drawn across the skin surface in a forward direction; and a friction surface situated in front of the razor blades, the friction surface including an array of raised separated projections, distal ends of the raised projections terminating in substantially flat faces, wherein a total area of the flat faces is greater than 10% of the area of the friction surface.

Furthermore, in accordance with some embodiments of the present invention, each of the raised projections is made of an elastomer.

Furthermore, in accordance with some embodiments of the present invention, the total area of the flat faces is greater than 20% of the area of the friction surface.

Furthermore, in accordance with some embodiments of the present invention, the total area of the flat faces is less than 90% of the area of the friction surface.

Furthermore, in accordance with some embodiments of the present invention, an aspect ratio of each of the raised projections is less than 2.

Furthermore, in accordance with some embodiments of the present invention, the aspect ratio is less than 1.

Furthermore, in accordance with some embodiments of the present invention, adjacent projections of the array of raised projections are separated by channels.

Furthermore, in accordance with some embodiments of the present invention, a majority of the channels are oriented such that a long dimension of each channel of the majority is oriented substantially parallel to the forward direction or at an oblique angle to the forward direction.

Furthermore, in accordance with some embodiments of the present invention, each of the channels has a substantially rectangular cross-sectional profile.

Furthermore, in accordance with some embodiments of the present invention, each of the channels has a substantially V-shaped cross-sectional profile.

Furthermore, in accordance with some embodiments of the present invention, each of the channels has a substantially inverted arch cross-sectional profile.

Furthermore, in accordance with some embodiments of the present invention, each of the faces has a substantially hexagonal shape.

Furthermore, in accordance with some embodiments of the present invention, each of the faces has a substantially parallelogram shape.

Furthermore, in accordance with some embodiments of the present invention, each of the faces has a shape that is substantially in the form of a chevron.

Furthermore, in accordance with some embodiments of the present invention, each of the faces has shape with a curved side.

Furthermore, in accordance with some embodiments of the present invention, each of the faces has a shape that is substantially in the form of an elongated symmetric teardrop.

Furthermore, in accordance with some embodiments of the present invention, the device is configured to attach to a handle.

Furthermore, in accordance with some embodiments of the present invention, the device further includes a lubricant dispenser.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 shows a razor that incorporates a razor blade assembly with a friction surface, in accordance with an embodiment of the present invention.

FIG. 2 shows a razor blade assembly with a friction surface, in accordance with an embodiment of the present invention.

FIG. 3 shows a razor blade assembly with an alternative configuration of a friction surface, in accordance with an embodiment of the present invention.

FIG. 4A shows a pattern of hexagonal projections for a friction surface of a razor blade assembly, in accordance with an embodiment of the present invention.

FIG. 4B shows a pattern of parallelogram projections for a friction surface of a razor blade assembly, in accordance with an embodiment of the present invention.

FIG. 4C shows a pattern of chevron projections for a friction surface of a razor blade assembly, in accordance with an embodiment of the present invention.

FIG. 4D shows a pattern of split chevron projections for a friction surface of a razor blade assembly, in accordance with an embodiment of the present invention.

FIG. 4E shows a pattern of teardrop projections for a friction surface of a razor blade assembly, in accordance with an embodiment of the present invention.

FIG. 5A shows a pattern of channels with rectangular cross section for a friction surface of a razor blade assembly, in accordance with an embodiment of the present invention.

FIG. 5B shows a pattern of channels with V-shaped cross section for a friction surface of a razor blade assembly, in accordance with an embodiment of the present invention.

FIG. 5C shows a pattern of channels with inverted arch cross section for a friction surface of a razor blade assembly, in accordance with an embodiment of the present invention.

FIG. 5D shows a pattern of channels with trapezoidal cross section for a friction surface of a razor blade assembly, in accordance with an embodiment of the present invention.

FIG. 5E shows a pattern of channels with rounded-corner trapezoidal cross section for a friction surface of a razor blade assembly, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

In accordance with some embodiments of the present invention, a razor blade assembly, such as a razor cartridge or a head of a disposable razor, includes a friction surface that is configured to stretch the surface of skin that is being shaved by the blades.

A razor blade assembly includes one or more razor blades. A typical razor blade assembly is designed to shave a skin surface when drawn across the skin surface such that the motion of the razor blade assembly includes a component of motion in a predefined direction. Typically (but not always), the predefined direction is substantially perpendicular to an orientation of the blades. The predefined direction in which the razor blade assembly is herein referred to as the forward direction. For example, the razor blade assembly may be configured to shave the skin surface when drawn across the skin surface in the forward direction. Similarly, the razor blade assembly may be configured to shave the skin surface when drawn across the skin surface in a diagonal direction that combines motion in the forward direction with motion in a lateral direction (perpendicular to the forward direction).

For example, the razor blades in the razor blade assembly may be mounted so as to be inclined relative to the skin surface when the razor blade assembly is positioned for shaving (e.g., with the cutting edges of the blades placed adjacent to the skin surface). The direction toward which the cutting edges are inclined defines the forward direction.

In accordance with some embodiments of the present invention, the friction surface is mounted on the razor blade assembly in front of the razor blades. (“In front of” herein refers to placement such that the friction surface passes over a point on the skin surface ahead of the cutting edges of the blades when the razor blade assembly is in use and moving across the skin surface in the forward direction.) Thus, when the razor blade assembly is drawn across the skin surface in the forward direction, the friction surface may engage a region of the skin surface that is ahead of the razor blades. Drawing the razor blade assembly across the skin surface may thus stretch the skin in the vicinity of the razor blades of the razor blade assembly. Stretching the skin in the vicinity of the razor blades may facilitate closer and more efficient shaving of the stretched region of skin by the razor blades.

In accordance with an embodiment of the present invention, the friction surface includes structure that is made of, or includes, friction enhancing material, such as, for example, rubber or another elastomer or elastomeric material. The structure includes a plurality of raised projections that are separated from one another. For example, the raised projections may be separated from one another by grooves or channels, or by holes, openings, or spaces. The distal end (from the end of the raised projection that is attached to the remainder of the friction surface) of each raised projection terminates in a face that is substantially flat, or nearly flat. The shape of the flat face may be polygonal, may be bounded by curved boundaries, or may be bounded by a combination of straight and curved segments.

The flat distal end of each raised projection is configured to contact the skin surface across which the razor blade assembly is being drawn. The contact between the flat distal end and the skin surface results in a friction force between the raised projection and the skin.

The channels between the raised projections may serve to facilitate evacuation of any lubricant or other fluid substance from between the flat distal end and the skin surface. Some or all of the channels may be arranged such that the long dimension of each channel is parallel to, or at an oblique angle to the forward direction. Some of the channels may be oriented such that the long dimension of each of those channels is oriented substantially perpendicular to the forward direction.

For example, a majority of the channels may be oriented such that the long dimensions of those channels are either substantially parallel to, or form an oblique angle with, the forward direction. A minority of the channels may be oriented substantially perpendicular to the forward direction.

When the flat distal end of a raised projection is pressed against the skin surface and moved in the forward direction, lubricant that is between the flat end and the skin surface may be squeezed out. The squeezed out lubricant may be channeled away via the channels, thus preventing the squeezed out lubricant from entering between a flat face of another raised projection and the skin surface. Some or all of the channels may be preferably oriented in a direction that is not perpendicular to the direction of motion (forward direction) of the friction surface over the skin surface. These (non-perpendicular) channels may convey the lubricant past the raised projection or outward from or around the raised projection. (In some cases, a channel that is oriented perpendicular to the direction of motion could enable lubricant to accumulate or build up in the perpendicular channel ahead of a raised projection, possibly interfering with action of the friction surface in stretching the skin surface.).

The contact between the flat ends and the skin surface, together with the channeling action of the channels, enables effective creation of a friction force between the flat ends and the skin surface. The effective creation of friction may thus result in effective stretching of the skin when the friction surface is pulled across the skin surface

Each raised projection is characterizable by an aspect ratio. The aspect ratio relates a representative lateral dimension of the raised projection to a representative height of the raised projection. The aspect ratio, as used herein, is defined as the ratio of the representative height to the representative lateral dimension (height divided by the lateral dimension).

The representative lateral dimension may be defined in a manner appropriate to the shape of the flat distal end of the raised projection. The representative lateral dimension may include, for example, a representative width, length, diameter, axis length, diagonal distance, or other distance between substantially opposite sides of the flat end. For example, the representative lateral dimension for a rectangular or parallelogram-shaped flat end may include a length, width, diagonal dimension, or other defined length of the flat end. An elliptic flat end may be characterized by a representative lateral dimension in the form of a length of a major axis, minor axis, average diameter, or other representative distance. A polygonal flat end may be characterized by a representative lateral dimension in the form of a distance (e.g., perpendicular distance) between opposite sides, between opposite vertices, or another representative distance.

The height of the raised projection may be defined as a distance between the flat distal end of the projection, and a floor of a channel that is adjacent to the raised projection. In a case where the floor of the channel is not flat (in cross section), the height may be defined as an average distance, a maximum distance, or other representative distance between the floor of the channel and the flat end.

In accordance with some embodiments of the present invention, the aspect ratio of each raised projection is no greater than 2. In some embodiments, the aspect ratio is no greater than 1. In some other embodiments, the aspect ratio may be less than one half.

A low aspect ratio (less than 2) may be advantageous. For example, a low aspect ratio may enable the raised projections to resist bending when sliding over the skin surface. In this manner, the flat ends of the raised projections may remain in contact with the skin surface when the razor blade assembly is drawn over the skin surface. Thus, the friction force between the friction surface and the skin surface may remain approximately constant during shaving. Such friction may stretch the skin being shaved, and thus facilitate cutting of hairs by razor blades of the razor blade assembly.

Such raised projections with low aspect ratio may provide greater friction than a strip of projections in the form of (high aspect ratio) narrow cylinders such as is found in some previously described safety razor cartridges. The strips on such safety razor cartridges may not create sufficient friction to stretch the skin in a manner to effectively facilitate shaving.

The friction surface, or a portion of the friction surface, may be characterized by an area density of the raised projections. As used herein, the area density of the friction surface is defined as the total area of the flat faces at the distal ends of the raised projections in the friction surface being characterized, divided by the total area of that friction surface (that includes the area of spaces or channels that separate the raised projections, and the projected area of any sloped walls of the raised projections). In accordance with some embodiments of the present invention, the area density is at least 10%. In some other embodiments the area density is at least 20%, at least 30%, at least 40%, at least 50%, at least 60%, at least 70%, or at least 80%. In some embodiments, the area density is no larger than 99%. In some embodiments, the area density is no larger than 90%.

The area density of the friction surface may be sufficient so as to ensure that the friction between the friction surface and the skin surface is sufficiently large to stretch the skin. The area density is sufficiently small to enable effective channeling of lubricant.

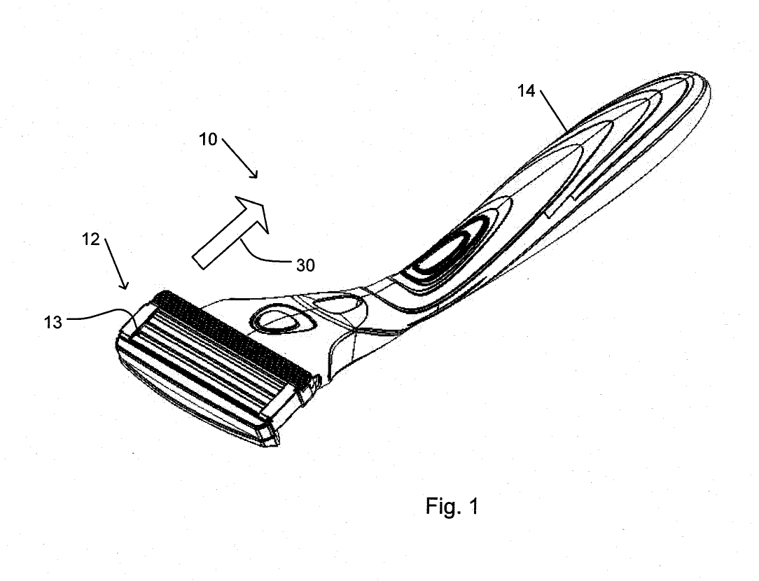

FIG. 1 shows a razor that incorporates a razor blade assembly with a friction surface, in accordance with an embodiment of the present invention.

Razor 10 includes razor blade assembly 12 that is mounted on handle 14. Razor blade assembly 12 may be configured to attach to, detach from, and reattach to, handle 14, or may be permanently attached to handle 14 (e.g., as part of a disposable razor). For example, handle 14 and razor blade assembly 12 may incorporate cooperating structure that enables attachment of razor blade assembly 20 to handle 14, or detachment of razor blade assembly 20 from handle 14.

Shaving surface 13 of razor blade assembly 12 is designed to be held against a skin surface to be shaved. When shaving surface 13 is placed against the skin surface, the skin surface may be shaved by drawing razor 10 and razor blade assembly 12 in the general direction indicated by forward direction arrow 30, or across the skin surface in a diagonal direction that includes a component of motion in the direction indicated by forward direction arrow 30.

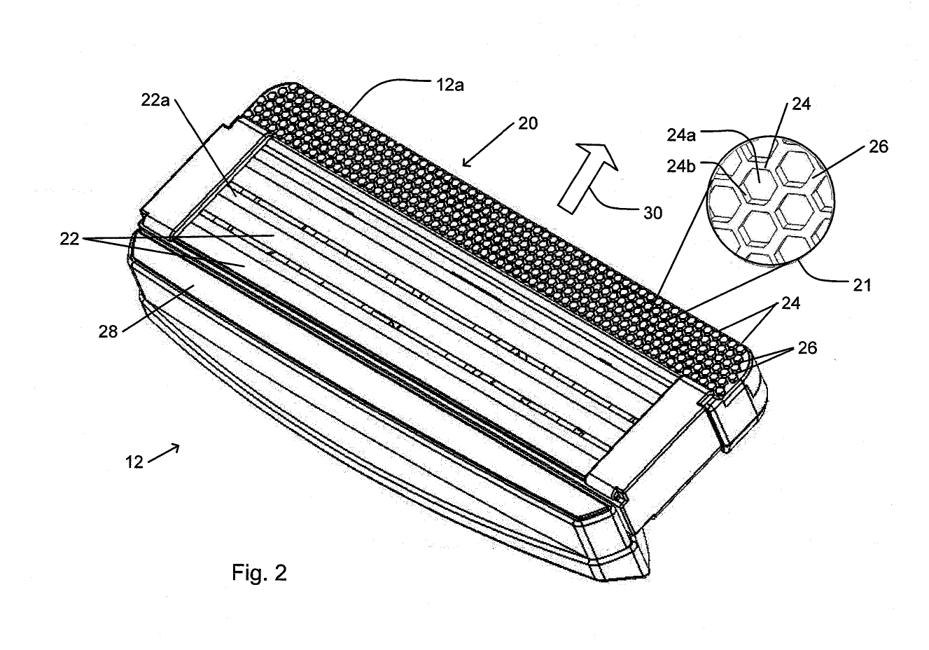

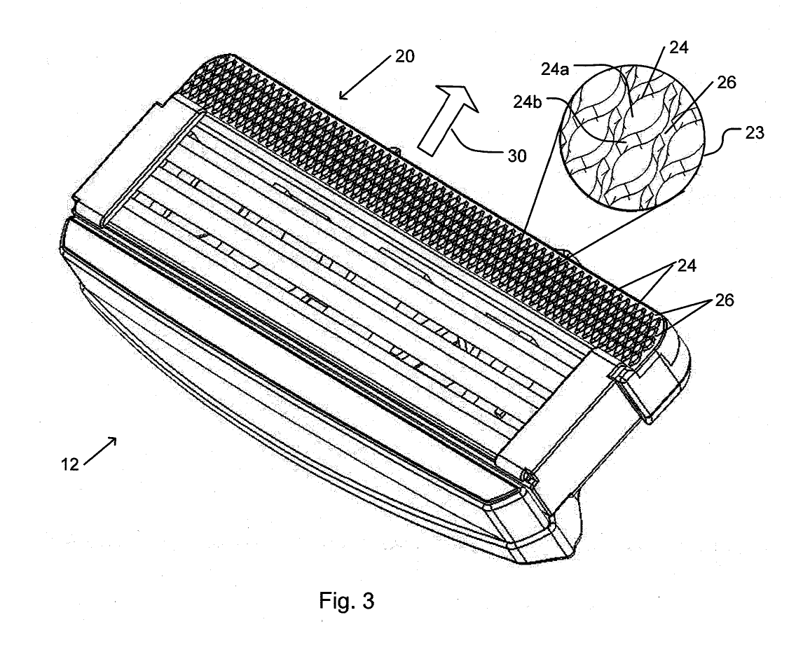

FIG. 2 shows a razor blade assembly with a friction surface, in accordance with an embodiment of the present invention. FIG. 3 shows a razor blade assembly with an alternative configuration of a friction surface, in accordance with an embodiment of the present invention.

Razor blade assembly 12 includes razor blades 22 and friction surface 20.

Razor blades 22 are held and arranged diagonally in razor blade assembly 12. The diagonal arrangement is such that cutting edge 22a of each razor blade 22 is oriented toward leading side 12a of razor blade assembly 12. Thus, when razor blade assembly 12 is pulled across a skin surface in forward direction 30, cutting edge 22a is positioned to shave hairs on the skin surface.

Friction surface 20 is positioned adjacent to leading side 12a of razor blade assembly 12. Friction surface 20 includes an array of raised projections 24.

Raised projections 24 may be made of a material with a high coefficient of friction with respect to sliding over skin. Raised projections 24 may be constructed of rubber or another elastomeric material. For example, friction surface 20 with raised projections 24 may be formed by a molding process, or may be otherwise shaped.

Raised projections 24 are configured to create a friction force when placed in contact with a skin surface. For example, each raised projection 24 may include, at its end that is distal to razor assembly 12, a flat face 24a. (Flat face 24a may be approximately or substantially flat.) Each raised projection 24 has one or more projection walls 24b. Projection walls 24b of a raised projection 24 may, in some cases, be substantially flat and substantially perpendicular to flat face 24a of the same raised projection 24. In other examples, projection walls 24b may be slanted or curved.

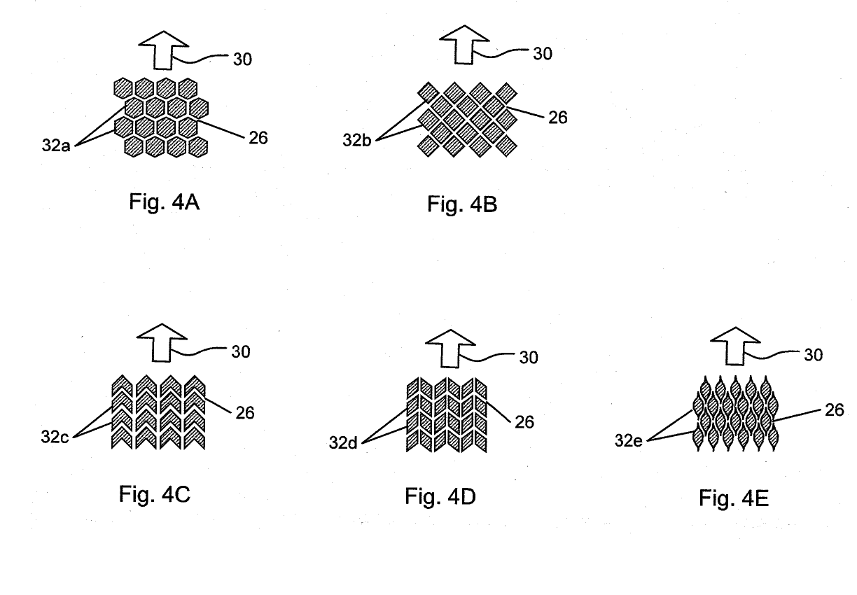

Flat face 24a may be formed in a shape that enables efficient filling of friction surface 20 with a dense array of raised projections 24. In the example shown in enlarged region 21 of friction surface 20 (FIG. 2), each flat face 24a has a regular hexagonal shape. In the example shown in enlarged region 23 of friction surface 20 (FIG. 3), each flat face 24a has an elongated symmetric teardrop shape. Other examples of shapes for flat faces 24a are described below (in connection with FIGS. 4A-4E).

Razor blade assembly 20 may include additional structure to facilitate use of razor blade assembly 20 in shaving, or to enhance comfort during shaving. For example, razor blade assembly 20 may include a lubricant dispenser 28. Lubricant dispenser 28 may include, for example, an absorbent strip that is saturated with a lubricant fluid. Contact between the absorbent strip of lubricant dispenser 28 and the skin surface causes lubricant to be deposited on the skin surface. Additional structure may be configured to hold components of razor blade assembly in place, to prevent accidental cutting of the skin surface by razor blades 22a, and to enable attachment of razor blade assembly 12 to a handle of a razor.

Each flat face 24a may be characterized by a representative lateral dimension. In the example of a regular hexagonal shape (see FIG. 2), the representative lateral dimension may be taken to be a distance between opposite sides of the hexagon, a distance between opposite vertices of the hexagon, a length of each side of the hexagon, or another representative length. In the example of an elongated symmetric teardrop shape (see FIG. 3), the representative lateral dimension may be the distance between the opposite sharp points of the teardrop shape, the maximum width of the teardrop shape, or another representative length.

Each pair of adjacent raised projections 24 is separated by a channel 26. The height of each projection wall 24b forms a wall of the channel. The height of the projection wall 24b may be defined as perpendicular (to flat face 24a) distance between flat face 24a and the floor of the adjacent channel 26. (When the side walls of a channel 26 are not vertical, e.g., not perpendicular to flat face 24a, the floor of the channel may be defined as the widthwise midline of the channel, or in another manner.)

The aspect ratio of a raised projection 24 may then be defined as the height of a projection wall 24b divided by the representative lateral dimension that characterizes flat face 24a of that raised projection 24. In accordance with embodiments of the present invention, the aspect ratio of a raised projection 20 is no greater than 2, or, typically, no greater than 1. A low aspect ratio may inhibit bending of raised projections 24.

The area density of a region of friction surface 20 may be defined as the area of all flat faces 24a of all raised projections 24 in that region, divided by the total area of that region. (The total area includes the area of all flat faces 24a in the region, plus the area of all channels 26 in that region.) In accordance with embodiments of the present invention, the area density of a friction surface 20 is at least 10%, or typically, at least 20%. On the other hand, the area density of a friction surface 20 is no greater than 99%, and typically less than 90%. An area density in this range may ensure sufficient friction (e.g., to stretch the skin) when friction surface 20 is slid over a skin surface, while ensuring sufficient channels to effectively channel lubricant away from friction surface 20.

Some or all of channels 26 may be arranged such that those channels 26 are not oriented perpendicular to forward direction 30. Examples of patterns of projections 24 that are densely packed, and with no channels 26 that are oriented perpendicular to forward direction 30, are shown in FIGS. 4A-4E for differently shapes of flat faces 24a. A non-perpendicular orientation of channels 26 may facilitate channeling a lubricant out of friction surface 20 when friction surface 20 is moved in forward direction 30.

FIG. 4A shows a pattern of hexagonal projections for a friction surface of a razor blade assembly, in accordance with an embodiment of the present invention. Hexagonal faces 32a, as shown, are oriented such that all channels 26 formed by sides of hexagonal faces 32a are either substantially parallel to forward direction 30, or are oriented at an oblique angle to forward direction 30. For example, each hexagonal face 32a may be oriented such that a line connecting opposite vertices is oriented substantially parallel to forward direction 30.

In some embodiments of the present invention, the pattern may be rotated by about 30° so that two of the six channels 26 that surround each hexagonal face 32a are substantially perpendicular to forward direction 30. In this case, the zigzag pattern formed by the remaining channels 26 may effectively channel the lubricant.

FIG. 4B shows a pattern of parallelogram projections for a friction surface of a razor blade assembly, in accordance with an embodiment of the present invention. Parallelogram faces 32b (in the illustrated example, square faces) are oriented in a diamond pattern such that channels 26 formed by sides of square faces 32b are oriented at an oblique angle (e.g., 45°) with respect to forward direction 30. For example, a diagonal of each parallelogram face 32b may be oriented substantially parallel to forward direction 30. Other orientations may be used.

FIG. 4C shows a pattern of chevron projections for a friction surface of a razor blade assembly, in accordance with an embodiment of the present invention. Chevron faces 32c, as shown, are oriented such that all channels 26 formed by sides of chevron faces 32c are either substantially parallel to forward direction 30, or are oriented at an oblique angle to forward direction 30. Chevron faces 32c are oriented such that the central convex vertex faces forward direction 30. Other orientations may be used.

FIG. 4D shows a pattern of split chevron projections for a friction surface of a razor blade assembly, in accordance with an embodiment of the present invention. A split chevron pattern may be considered to be composed of a pattern of pairs of rhombus faces 32d, arranged in a pattern of rows and columns. For example, all rhombus faces 32d in a single column of the column are oriented the same. Along each row, adjacent rhombus faces 32d exhibit reflectional symmetry with respect to one another. Rhombus faces 32d, as shown, are oriented such that all channels 26 formed by sides of rhombus faces 32d are either substantially parallel to forward direction 30, or are oriented at an oblique angle to forward direction 30. For example, columns of the pattern may be oriented substantially parallel to forward direction 30. In this manner, a side of each rhombus face 32d is substantially parallel to forward direction 30. Other orientations may be used.

In accordance with some embodiments of the present invention, a face may have a shape with one or more curved sides.

FIG. 4E shows a pattern of teardrop projections for a friction surface of a razor blade assembly, in accordance with an embodiment of the present invention. Each elongated symmetric teardrop face 32e includes curved sides meeting at two points. The channels 26 formed between elongated symmetric teardrop faces 32e may be described as a pattern of osculating sinuous curves. The curves in the pattern of channels 26, as shown, are either substantially parallel to (momentarily tangent to the direction of) forward direction 30, or are oriented at an oblique angle to forward direction 30. For example, a line connected the pointed opposite ends of each elongated symmetric teardrop face 32e may be oriented substantially parallel to forward direction 30. Other orientations may be used. Faces may have other shapes with curved sides.

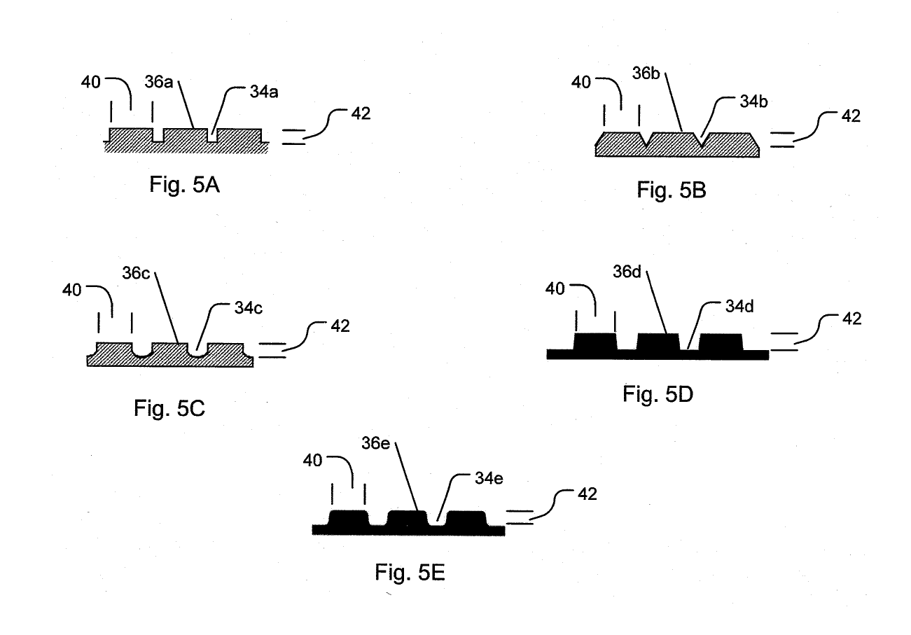

Channels 26 may have be formed with different cross-sectional profiles, depending on the form of walls of the raised projections. For example, channels 26 with one cross-sectional profile may be effective for channeling one type of lubricant, but less effective in channeling a different type of lubricant. Different channel profiles may also contribute to stiffness or another property of the raised projections. Various channel profiles are illustrated in FIGS. 5A-5C.

FIG. 5A shows a pattern of channels with rectangular cross section for a friction surface of a razor blade assembly, in accordance with an embodiment of the present invention.

Rectangular section channels 34a separate raised projections 36a with vertical walls. Length 40 schematically represents a representative lateral dimension of raised projection 36a. Height 42 represents a representative height of raised projection 36a.

FIG. 5B shows a pattern of channels with a V-shaped cross section for a friction surface of a razor blade assembly, in accordance with an embodiment of the present invention.

V-shaped section channels 34b (or inverted triangular channels) separate raised projections 36b with sloped walls (and trapezoidal profile). Length 40 schematically represents a representative lateral dimension of raised projection 36b. As shown, length 40 represents a length that characterizes the upper base of the trapezoidal profile. Other lengths (e.g., the length of the lower base or at half the height) may be used as the representative lateral dimension. Height 42 represents a representative height of raised projection 36a, here taken from the bottom of V-shaped section channel 34b to the top of raised projection 36b.

FIG. 5C shows a pattern of channels with inverted arch cross section for a friction surface of a razor blade assembly, in accordance with an embodiment of the present invention.

Inverted arch section channels 34c separate raised projections 36c with concavely curved walls. Length 40 schematically represents a representative lateral dimension of raised projection 36c. As shown, length 40 represents a length that characterizes the top (flat) upper surface of raised projection 36c. Other lengths (e.g., the lateral length of raised projection 36c at a particular fraction of the height of raised projection 36c) may be used as the representative lateral dimension. Height 42 represents a representative height of raised projection 36c, here taken from the bottom of inverted arch section channel 34c to the top of raised projection 36c.

FIG. 5D shows a pattern of channels with trapezoidal cross section for a friction surface of a razor blade assembly, in accordance with an embodiment of the present invention.

Trapezoidal section channels 34d separate raised projections 36d with sloped walls (and trapezoidal profile). Length 40 schematically represents a representative lateral dimension of raised projection 36d. As shown, length 40 represents a length that characterizes the upper base of the trapezoidal profile of raised projection 36d. Other lengths (e.g., the length of the lower base or at half the height) may be used as the representative lateral dimension. Height 42 represents a representative height of raised projection 36a, here taken from the bottom of trapezoidal section channel 34d to the top of raised projection 36d.

FIG. 5E shows a pattern of channels with rounded-corner trapezoidal cross section for a friction surface of a razor blade assembly, in accordance with an embodiment of the present invention.

Rounded trapezoidal section channels 34e separate raised projections 36e with similarly rounded-corner trapezoidal profiles. Length 40 schematically represents a representative lateral dimension of raised projection 36e. As shown, length 40 represents a length that characterizes the top (flat) upper surface of raised projection 36e. Other lengths (e.g., the lateral length of raised projection 36e at a particular fraction of the height of raised projection 36e) may be used as the representative lateral dimension. Height 42 represents a representative height of raised projection 36e, here taken from the bottom of rounded trapezoidal section channel 34e to the top of raised projection 36e.

Patterns having raised projections with other profiles, and channels with other forms of cross section, may be used. A pattern may mix several types of raised projections or channels. Raised projections may have irregular faces, or faces that vary from one raised projection to another.

Measurements have been made comparing performance of a razor blade assembly with a friction surface, in accordance with embodiments of the present invention, with commercially available safety razor cartridges. The friction surface included raised projections with hexagonal flat faces. The diameters of each hexagonal face in different measurements were approximately 50 μm in some cases, and 700 μm in other cases. The coefficient of dynamic friction of each type of razor blade assembly (safety razor cartridge) was measured when the assembly was slid against human (inner forearm) skin lubricated with commercially available shaving foam. The measurements demonstrated that the razor blade assembly with a friction surface in accordance with an embodiment of the present invention has a significantly larger coefficient of dynamic friction than the coefficient of dynamic friction that was measured with commercially available safety razor cartridges.

1. A razor blade assembly device comprising:
one or a plurality of razor blades configured to shave a skin surface when drawn across the skin surface in a forward direction; and
a friction surface situated in front of said one or a plurality of razor blades, the friction surface including an array of raised separated projections, distal ends of the raised projections terminating in substantially flat faces, wherein a total area of the flat faces is greater than 10% of the area of the friction surface.

2. The device of claim 1, wherein each of the raised projections is made of an elastomer.

3. The device of claim 1, wherein the total area of the flat faces is greater than 20% of the area of the friction surface.

4. The device of claim 1, wherein the total area of the flat faces is less than 90% of the area of the friction surface.

5. The device of claim 1, wherein an aspect ratio of each of the raised projections is less than 2.

6. The device of claim 5, wherein the aspect ratio is less than 1.

7. The device of claim 1, wherein adjacent projections of the array of raised projections are separated by channels.

8. The device of claim 7, wherein a majority of the channels are oriented such that a long dimension of each channel of the majority is oriented substantially parallel to the forward direction or at an oblique angle to the forward direction.

9. The device of claim 7, wherein each of the channels has a substantially rectangular cross-sectional profile.

10. The device of claim 7, wherein each of the channels has a substantially V-shaped cross-sectional profile.

11. The device of claim 7, wherein each of the channels has a substantially inverted arch cross-sectional profile.

12. The device of claim 1, wherein each of the faces has a substantially hexagonal shape.

13. The device of claim 1, wherein each of the faces has a substantially parallelogram shape.

14. The device of claim 1, wherein each of the faces has a shape that is substantially in the form of a chevron.

15. The device of claim 1, wherein each of the faces has shape with a curved side.

16. The device of claim 1, wherein each of the faces has a shape that is substantially in the form of an elongated symmetric teardrop.

17. The device of claim 1, configured to attach to a handle.

18. The device of claim 1, further comprising a lubricant dispenser.
